(19) United States
(12) Patent Application Publication
(10) Pub. No.: US 2025/0173212 A1
(43) Pub. Date: May 29, 2025

(54) SYSTEMS AND METHODS FOR VERIFYING CONTENT DELIVERY IN A CDN

(71) Applicant: CenturyLink Intellectual Property LLC, Broomfield, CO (US)

(72) Inventor: Matthew BUSCHE, Lakewood, CO (US)

(73) Assignee: CenturyLink Intellectual Property LLC, Broomfield, CO (US)

(21) Appl. No.: 18/536,879

(22) Filed: Dec. 12, 2023

Related U.S. Application Data
(60) Provisional application No. 63/603,331, filed on Nov. 28, 2023.

(51) Int. Cl. G06F 11/07

(52) U.S. Cl. CPC G06F 11/079; G06F 11/0709

(57) ABSTRACT

Systems and methods for verifying content delivery in a content delivery network (CDN) are described. Content retrieval and routing in a CDN are tested using multiple test sequences that are each assigned to a different value of a parameter P and are generated using the assigned value of P. A client device can verify whether a test sequence received at the client device matches a test sequence requested by the client device (e.g., the correct content was) and verify that the received test sequence is assigned to the same value of P as the requested test sequence. The value of P assigned to the received test sequence can be extracted, by the client device, from the received test sequence to determine which test sequence was actually received, thereby providing information that can be used to help debug content delivery errors.

### CROSS-REFERENCE TO RELATED APPLICATIONS

This application claims the benefit of U.S. Provisional Application No. 63/603,331 filed Nov. 28, 2023, entitled “Systems and Methods for Verifying Content Delivery in a CDN,” which is incorporated herein by reference in its entirety.

### BACKGROUND

A content delivery network (CDN) is a geographically distributed network of servers that are used to deliver various forms of digital content, such as web pages or media content, to requesting client devices. Content is typically stored on an origin server of the CDN and distributed to (e.g., cached on) caching servers of the CDN that are geographically closer to the client devices to reduce content delivery latencies. In some cases, errors occur within the CDN that result in the wrong content being delivered to a requesting client device. It is with respect to this general technical environment that aspects of the present disclosure are directed.

### SUMMARY

The present application describes a method including: transmitting, to a server, a request for a portion of a first test sequence, wherein the first test sequence is associated with a numeric value P₁; generating the portion of the first test sequence; receiving, from the server, a portion of a second test sequence of N-bit values comprising a first N-bit value X_{A} followed sequentially by a second N-bit value X_{B}; determining a numeric difference value P₂ between X_{A} and X_{B}; determining that the portion of the second test sequence differs from the portion of the first test sequence; and in accordance with the determination that the portion of the second test sequence differs from the portion of the first test sequence, performing an error reporting procedure including reporting P₂.

In some examples, and in combination with any of the above aspects and examples, determining that the portion of the second test sequence differs from the portion of the first test sequence comprises determining that P₁ differs from P₂.

In some examples, and in combination with any of the above aspects and examples, the numeric difference P₂ is determined during the error reporting procedure.

In some examples, and in combination with any of the above aspects and examples, the request for the portion of the first test sequence includes an indication of P₁.

In some examples, and in combination with any of the above aspects and examples, the indication of P₁ is implicit in a uniform resource locator (URL) included in the request for the portion of the first test sequence.

In some examples, and in combination with any of the above aspects and examples, the method further includes: determining a first offset mᵢₙᵢₜ associated with a value of an element Xinit of the portion of the second test sequence based on the equation Xᵢₙᵢₜ=mᵢₙᵢₜP₂ mod 2^{N}, where determining that the portion of the second test sequence differs from the portion of the first test sequence includes determining that mᵢₙᵢₜ differs from a second offset of the portion of the first test sequence.

In some examples, and in combination with any of the above aspects and examples, the error reporting procedure includes reporting the first offset mᵢₙᵢₜ.

In some examples, and in combination with any of the above aspects and examples, the request includes an indication of the second offset of the portion of the first test sequence.

In some examples, and in combination with any of the above aspects and examples, the first offset mᵢₙᵢₜ is computed using an extended Euclidean algorithm to solve for mᵢₙᵢₜ in the equation Xᵢₙᵢₜ=mᵢₙᵢₜP₂ mod 2^{N}.

In some examples, and in combination with any of the above aspects and examples, the request includes an indication of N.

In some examples, and in combination with any of the above aspects and examples, the method further includes: obtaining P₁ and N, where the portion of the first test sequence is generated using P₁ and N in the equation Xₘ=mP₁ mod 2^{N}.

In some examples, and in combination with any of the above aspects and examples, P₁ is an odd integer having the property that equation Xₘ=mP₁ mod 2^{N} produces unique values of Xₘ for 0≤m≤2^{N}−1.

In some examples, and in combination with any of the above aspects and examples, the second test sequence includes a third N-bit value X_{D} sequentially following the second N-bit value X_{B}, where a numeric difference between X_{B} and X_{D} is P₂.

In other aspects, the present application describes a method that includes: receiving, from a requestor, a request for a portion of a first test sequence, where the request for the portion of the first test sequence includes an indication of a numeric value P₁ associated with the first test sequence; and in response to receiving the request for the portion of the first test sequence: identifying a first bit-length value N₁, generating the portion of the first test sequence by generating a sequence of N₁-bit values using the equation Xₘ=mP₁ mod 2^{N}₁, and transmitting the portion of the first test sequence to the requestor.

In some examples, and in combination with any of the above aspects and examples, the requestor is a first caching server or a first client device.

In some examples, and in combination with any of the above aspects and examples, the method further includes: receiving, from a second requestor, a request for a portion of a second test sequence, where the request for the second test sequence includes an indication of a numeric value P₂ associated with the second test sequence; and in response to receiving the request for the portion of the second test sequence: identifying a second bit-length value N₂, generating the portion of the second test sequence by generating a sequence of N₂-bit values using the equation Yₘ=mP₂ mod 2^{N}₂, and transmitting the portion of the second test sequence to the second edge server.

In other aspects, the present application describes a content delivery network (CDN) that includes: an origin server comprising at least a first processor and first memory operatively connected to the at least the first processor and storing first instructions; a caching server comprising at least a second processor and second memory operatively connected to the at least the second processor and storing second instructions; and a client device comprising at least a third processor and third memory operatively connected to the at least the third processor and storing third instructions, where the origin server is operatively connected to the caching server, and the first instructions, when executed by the at least the first processor, cause the origin server to perform a first method. The first method includes receiving, from the caching server, a first request for a first data stream, and in response to the first request: identifying a first value P₁ of a parameter P based on the first request, generating the first data stream based on P₁, and transmitting the first data stream to the caching server.

In some examples, and in combination with any of the above aspects and examples, the caching server is operatively connected to the client device, and the second instructions, when executed by the at least the second processor, cause the caching server to perform a second method. The second method includes: receiving a second request for a second data stream from the client device comprising an indication of a second value P₂ of a parameter P, and in response to receiving the second request: obtaining, from a cache of the caching server or from the origin server, a third data stream based on P₂, and transmitting the third data stream to the client device.

In some examples, and in combination with any of the above aspects and examples, the third instructions, when executed by the at least the third processor, cause the client device to perform a third method. The third method includes: transmitting a request for a fourth data stream to the caching server where the fourth request includes an indication of a third value P₃ of parameter P, generating the fourth data stream based on P₃, receiving a fifth data stream from the caching server, the fifth data stream comprising a sequence of N-bit values comprising a first N-bit value X_{A} followed sequentially by a second N-bit value X_{B}, determining, by the at least one client device, a fourth value P₄ of parameter P based on a difference between X_{A} and X_{B}, determining whether the third data stream differs from the fourth data stream, and in accordance with a determination that the third data stream differs from the fourth data stream, performing an error reporting procedure including reporting P₄.

In some examples, and in combination with any of the above aspects and examples, generating the first data stream based on P₁ includes generating a sequence of N₁-bit values using the equation Xₘ=mP₁ mod 2^{N1}.

In some examples, and in combination with any of the above aspects and examples, generating the fourth data stream based on P3 includes generating a sequence of N2-bit values using the equation Xₘ=mP₃ mod 2^{N2}.

In some examples, and in combination with any of the above aspects and examples, obtaining the third data stream based on P₂ includes sending, to the origin server, a request for the third data stream comprising an indication of P₂ and receiving the third data stream from the origin server.

This summary is provided to introduce a selection of concepts in a simplified form that are further described below in the Detailed Description. This summary is not intended to identify key features or essential features of the claimed subject matter, nor is it intended to be used to limit the scope of the claimed subject matter.

### BRIEF DESCRIPTION OF THE DRAWINGS

Non-limiting and non-exhaustive examples are described with reference to the following figures.

FIG. 1 depicts a system for verifying content delivery in a CDN according to aspects of the present application.

FIG. 2 depicts a system for verifying content delivery in a CDN according to aspects of the present application.

FIG. 3A depicts an example method for generating a test sequence according to aspects of the present application.

FIG. 3B depicts an example method for extracting parameters from a test sequence according to aspects of the present application.

FIG. 4 depicts an example test sequence generated according to aspects of the present application.

FIG. 5 depicts an example method for verifying content delivery in a CDN according to aspects of the present application.

FIGS. 6A-6B depict an example method for verifying content delivery in a CDN according to aspects of the present application.

FIG. 7 is a block diagram of an example computing device that can be employed in relation to the present application.

### DETAILED DESCRIPTION

A content delivery network (CDN) is a geographically distributed network of content servers that are used to deliver various forms of digital content, such as web pages or media content, to requesting client devices. The original content is typically stored on an origin server of the CDN and distributed to client devices via a hierarchy of caching servers of the CDN, where the caching servers are progressively geographically closer to the client devices to reduce content delivery latencies. When a client device requests a particular data stream (e.g., a particular movie or web page) from an edge server (e.g., a last-level caching server that is closest to the client device in the caching server hierarchy), the edge server either retrieves the requested content from a cache of the edge server (if the content stream is cached at the edge server) or (if some or all of the content stream is not cached at the edge server) requests the uncached portions of the content stream from a higher-level caching server or the origin server and relays the content stream to the client device.

In some cases, errors occur within a CDN that cause the wrong content to be delivered to a requesting client device. For example, a client device may request a first data stream (e.g., first content stored on a first origin server) and may instead receive a second data stream (e.g., different content stored on the first origin server or on another origin server). Similarly, a client device may request a first page of a first origin stream (e.g., a portion of the first data stream that starts at an offset within the first data stream, such as at a particular byte or frame) and may instead receive a different page of the first data stream, or may receive a different page of a different data stream. Such content-delivery errors may occur due to, for example, switching errors in the CDN, software bugs, or other types of content retrieval or routing errors.

To avoid content-delivery errors it is desirable to test the content retrieval and routing functionality of the CDN to ensure that the CDN is operating properly. As described herein, systems and methods for verifying content delivery in a CDN enable a client device to test whether a CDN is operating correctly by requesting content and verifying that the content received in response to the request matches the requested content. The client device and servers (e.g., the origin server, edge servers, and any intermediate caching servers) of the CDN perform this test using test sequences of binary N-bit values that are generated at both the client device and the origin server using a sequence generation formula based on a set of parameters that are known to the client device and provided to the origin server. Conceptually, the test sequences can be thought of as test data streams that are generated for the purposes of testing the CDN (e.g., rather than being provided by a third-party content provider).

To test the CDN, the client device requests a particular test sequence from a content server (e.g., a test sequence of binary numbers that is generated using a particular set of parameters), generates the test sequence locally, and compares the test sequence received from the content server (e.g., the edge server or origin server) to the locally generated test sequence to determine whether the correct test sequence was received. A particular test sequence X having elements Xₘ is generated using the sequence generation formula Xₘ=mP mod 2^{N} where parameter m is an index of a value in the test sequence (e.g., an offset into the sequence), parameter P is a unique odd number that is assigned to (e.g., associated with) the particular test sequence, and parameter N is the number of bits per value in the test sequence. For relatively large values of N (e.g., 32 or 64), the sequence generation formula produces a large number (2^{N}−1) of non-repeating values that are pseudo-randomized. Thus, the test sequences can be used to effectively exercise the CDN in a manner that can reveal errors in the CDN's behavior.

As described herein, the above-described method of generating test sequences enables the client device to detect errors in content delivery and to extract additional debugging information from the received test sequence that may help identify the source of errors (if any). The debugging information includes an indication of which test sequence was received and at which offset, which can be used to help determine why the error occurred.

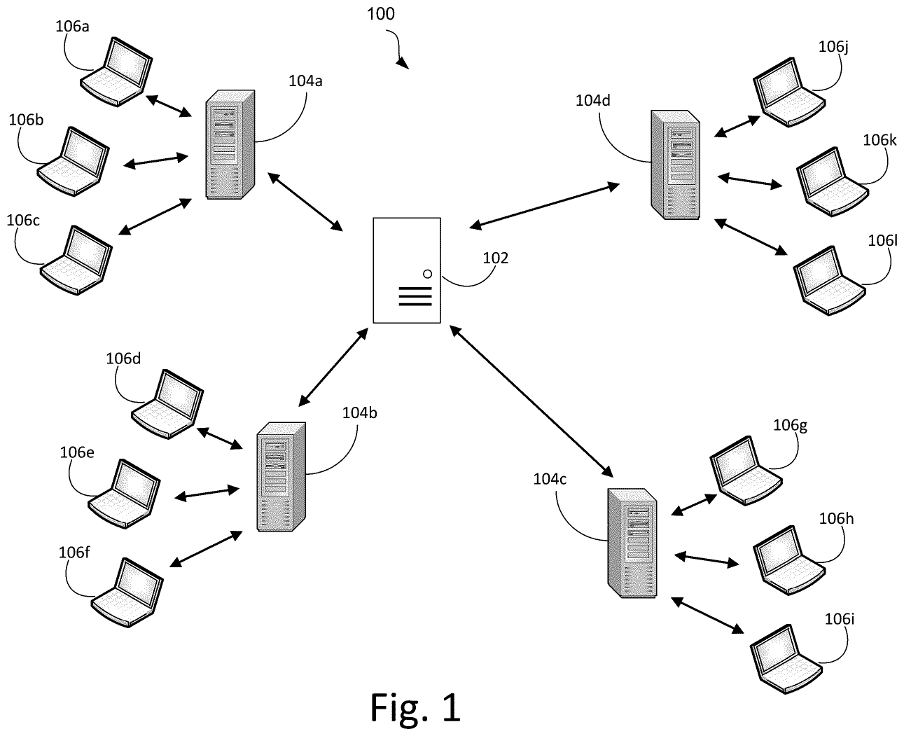

Additional details regarding methods and systems that can be used to implement aspects of the above-described features are described with reference to FIGS. 1-7.

FIG. 1 depicts an example of a CDN 100 that can be used for verifying content delivery. The CDN 100 includes an origin server 102 that can be used for storing content provided by a third-party content provider and/or for generating and/or storing test sequences that may be used to test the CDN 100 as described herein. The origin server 102 is communicatively coupled with edge servers 104a-d (which may be collectively referred to as edge servers 104). The edge servers 104a-d are configured to obtain content from the origin server 102, cache content obtained from the origin server 102, and provide content to client devices 106a-1 in response to receiving requests for content from the client devices 106a-1 (which may be collectively referred to as client devices 106). For example, edge server 104a is communicatively (e.g., operatively) coupled with client devices 106a-c and configured to receive requests for content from client devices 106a-c, obtain the requested content from a cache of the edge server 104a (if the requested content is cached at the edge server 104a), and/or from a higher-level caching server (if there are additional caching servers between the edge server and the origin server 102) or the origin server 102 (if the requested content is not cached). Edge server 104a then provides the content to the requesting client device 106a-c.

As briefly mentioned above, although CDN 100 depicts a two-level hierarchy of content servers that includes a top-level origin server 102 and multiple lower-level edge servers 104, it should be understood that, in some cases, a CDN includes additional caching server hierarchy levels (e.g., additional caching servers between edge servers 104 and the origin server 102) that serve as intermediate caches for content to be delivered to client devices 106a-1. In some examples, CDN 100 is an operating CDN (working in production) that is being tested dynamically. In other examples, the CDN 100 is a test network. In examples where CND 100 is a test network, it will be appreciated that mimicking a production CDN as closely as possible will enable the most robust testing.

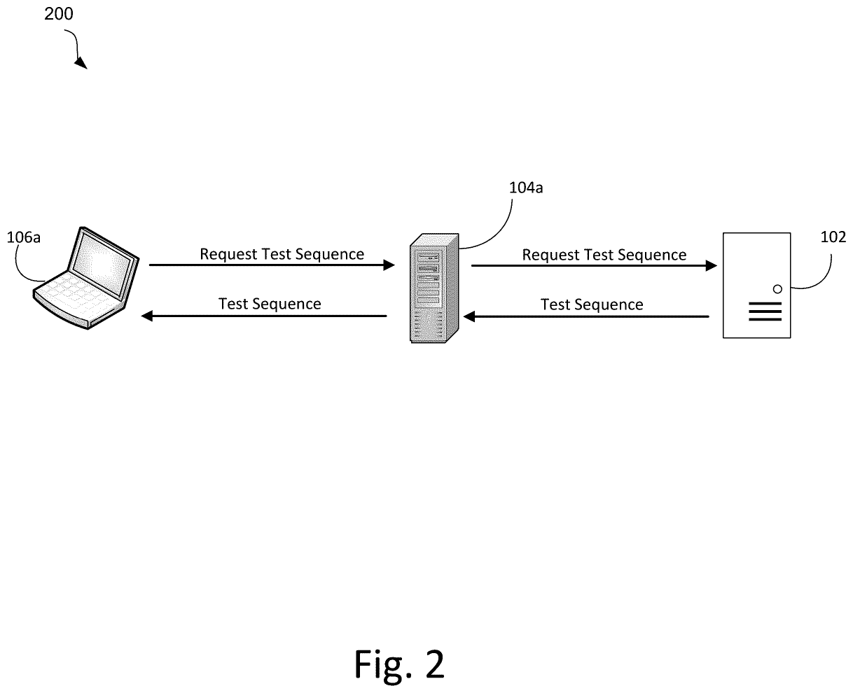

FIG. 2 depicts a system 200 that can be used for verifying content delivery. The system 200 represents a portion of CDN 100 described with reference to FIG. 1, including a client device 106a, an edge server 104a, and the origin server 102. The client device 106a can initiate a procedure to test the system 200 (and/or CDN 100) by transmitting, to the edge server 104a, a request for a test sequence (e.g., a test sequence to be generated using the test sequence generation formula with parameters P, m, and N as described above). In some examples, the request for the test sequence includes an indication of one or more of the parameters used in the test sequence generation formula. For example, the request may include an indication of a value of parameter P associated with the requested test sequence to enable the origin server to generate the correct test sequence, a value of an initial offset mᵢₙᵢₜ that specifies the offset of the requested test sequence (e.g., the index of the first value of the test sequence), and/or a value of N (e.g., specifying the number of bits per value of the test sequence). In some examples, the request includes an indication of a length of the test sequence (e.g., specifying how many values should be included in the requested test sequence). In some examples, the indication of the length includes a number of bytes, or a number of values of the test sequence, or a final (ending) index value m_{final} (e.g., an index of the last value in the test sequence).

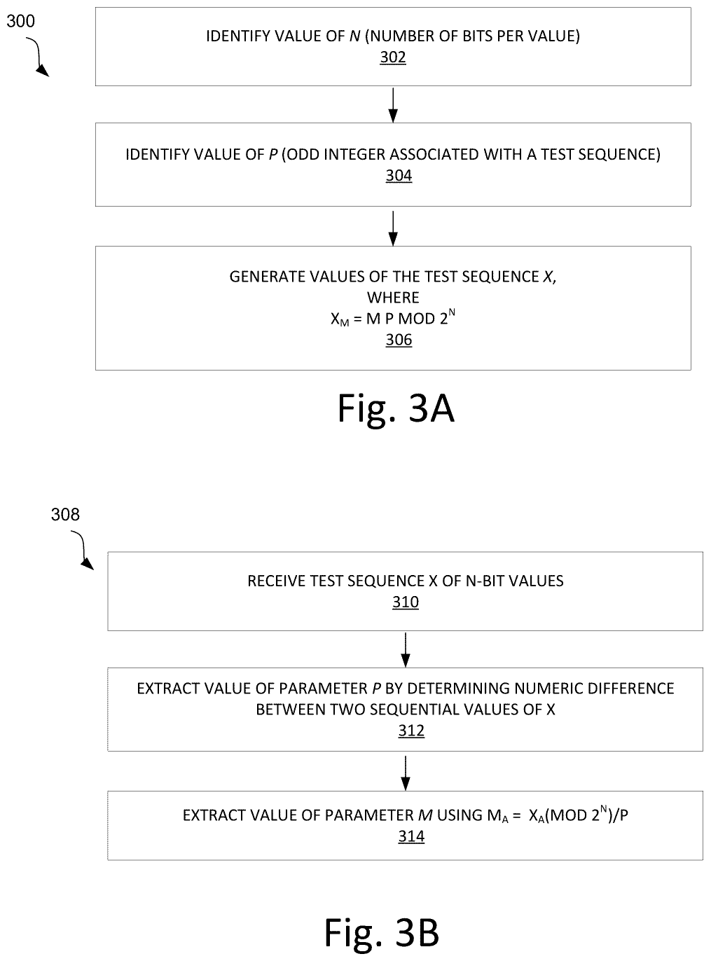

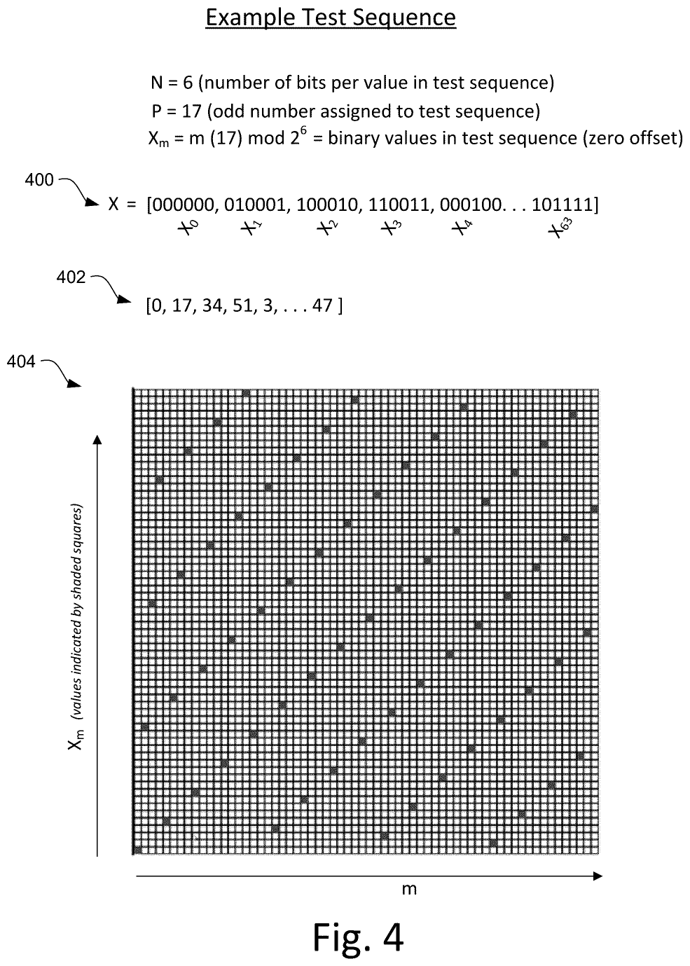

The edge server 104a receives the request for the test sequence and obtains a test sequence in response to the request. For example, the edge server 104a obtains the test sequence by generating the test sequence based on the request (e.g., using a sequence generation formula as described with reference to FIG. 3), or by retrieving the test sequence from a cache of the edge server 104a (e.g., based on the parameters), and/or by transmitting a request for a test sequence to a higher-level caching server or the origin server 102 and receiving a test sequence from the higher-level caching server or the origin server 102. The edge server 104a provides the obtained test sequence to the client device 106a. Depending on the desired testing coverage, the edge server 104a may be exercised to obtain a test sequence (at least partially) from cache storage and/or from origin server 102 during different test scenarios.

As mentioned above, the test sequence generation formula is designed to enable the client device 106a to detect errors in content delivery and also to extract debugging information, such as described in more detail with reference to FIG. 3B. For example, because each test sequence is assigned (e.g., generated using) a unique value of P, the client device can determine which particular (wrong) test sequence was received at the client device based on the value of P extracted from the received test sequence. Such debugging information can be useful for debugging network errors and understanding how and why the wrong test sequence was delivered to the client device. The client device 106a can also extract an offset of the received test sequence (such as an index of the first value in the received test sequence), which may be useful debugging information when the client device 106a receives the wrong page of the correct test sequence or the wrong page of the wrong test sequence.

If the system 200 is functioning correctly, the test sequence received by the client device 106a from the edge server 104a is the correct test sequence (e.g., it is the requested test sequence). If the system 200 is not functioning correctly, the test sequence received by the client device 106a from the edge server 104a is the wrong test sequence (e.g., it is not the requested test sequence). The latter scenario may occur if, for example, the edge server 104a obtains some or all of the wrong test sequence from its own cache or from the cache of a higher-level caching server, requests or receives the wrong test sequence from the origin server 102, and/or due to other errors in retrieving or routing the test sequence to the client device 106a.

In some examples, the client device 106 determines whether the received test sequence differs from the requested test sequence (e.g., whether the correct sequence was received) by generating the requested test sequence locally (e.g., using the sequence generation formula and the values of the parameters P, m, and N of the requested test sequence) and comparing the generated requested test sequence with the received test sequence. In some examples, the client device 106a extracts, from the received test sequence, a value of parameter P corresponding to the received test sequence and/or a value of an offset mᵢₙᵢₜ of the received test sequence (e.g., the first index value of the received test sequence), as described in more detail with reference to FIG. 3B. In some examples, the client device 106a determines whether the received test sequence differs from the requested test sequence by determining whether the value of P extracted from the received test sequence matches the value of P corresponding to the requested test sequence, and/or whether the value of mᵢₙᵢₜ extracted from the received test sequence matches the value of mᵢₙᵢₜ corresponding to the requested test sequence.

FIG. 3A depicts an example method 300 for generating a test sequence using the sequence generation equation Xₘ=m P mod 2^{N}. Method 300 may be performed by a client device (e.g., client device 106), an edge server or other caching server (e.g., edge server 104), and/or an origin server (e.g., origin server 102).

At operation 302, a value of parameter N is identified, where N is the number of bits per binary value of the test sequence to be generated (e.g., 4, 6, 8, 16, 32, 64, or 128 bits). In some examples, the value of N is identified based on information retrieved from storage, such as a configuration setting. In some examples, the value of N is identified based on a received request for a test sequence (e.g., the request for the test sequence includes an indication of the value of N). For example, an origin server may determine the value of N based on a request for a test sequence received from a caching server or client device.

At operation 304, a value of parameter P is identified, where (in this example) P is an odd number associated with the test sequence. In some examples, P is an odd integer having the property that P is relatively prime to the modulo window of the sequence generation equation (e.g., mod 2^{N}). In some examples, the value of P is identified based on information retrieved from storage. In some examples, the value of P is identified based on a received request for a test sequence. For example, an origin server may determine the value of P based on a request for a test sequence received from an edge server or client device. In some examples, the value of P is identified based on an output of a random number generator that produces odd integers. For example, a client device may generate a value of P using a number generator and then request a test sequence associated with the generated value of P (such as by including the value of P in the request). In examples, the values of N and P identified in operations 302 and 304 may be identified according to an automated testing algorithm operating on the client device.

At operation 306, values of the test sequence X are generated using the equation Xₘ=m P mod 2^{N}, where m is the index (e.g., offset) of each value of the test sequence X. In some examples, m is incremented by one for each value Xₘ of X. In some examples, m ranges from an initial offset value mᵢₙᵢₜ to 2^{N}−1, thereby guaranteeing that each value Xₘ in the test sequence X is unique. Moreover, because the values of the test sequence X are unique over the range of m=0 to 2^{N}−1, the value of m for each value of the test sequence is also unique; e.g., no two values of the test sequence will yield the same value of m when solving for m in the equation Xₘ=m P mod 2^{N}.

FIG. 3B depicts an example method 308 for extracting parameters from a received test sequence. Method 308 may be performed by a client device (e.g., client device 106).

At operation 310, a test sequence X of N-bit values is received. For example, a test sequence X is received by a client device from an edge server or an origin server. In some test example scenarios, the test sequence X that is received may have been obtained from multiple places within the CDN. For example, in the CDN depicted in FIG. 1, the received test sequence X may be served partially by an edge server 104 that has previously cached a portion of the requested test sequence and partially from an origin server 102.

At operation 312, a value of parameter P is extracted from the received test sequence X by determining a numeric difference between two consecutive values of X. For example, the value of P may be extracted by determining a numeric difference between the first two values of X, such as X₀ and X₁ (assuming mᵢₙᵢₜ=0) by subtracting X₀ from X₁.

At operation 314, a value of parameter m is extracted from the received test sequence X, such as by determining a value of an index mᵢₙᵢₜ the first value (Xᵢₙᵢₜ) of the received test sequence X based on the equation Xₘᵢₙᵢₜ=mᵢₙᵢₜ P mod 2^{N}. In some examples, the value of parameter mᵢₙᵢₜ for the first value of the received test sequence Xᵢₙᵢₜ corresponds to an offset of the received test sequence X. For example, if the index of the first value of the sequence is 0, then mᵢₙᵢₜ is 0 (e.g., there is no offset). If the index of the first value of the test sequence is 12 (e.g., the test sequence starts from an offset of 12), then mᵢₙᵢₜ is 12. In some examples, the value of parameter mᵢₙᵢₜ is determined using an extended Euclidian algorithm or another appropriate algorithm. In some examples, multiple values of parameter m are extracted from the received test sequence. For example, a client device may determine values of m for some or all of the values of the test sequence (e.g., by solving X_{A}=MAP mod 2^{N} for multiple values of A) to identify errors in the received test sequence, such as to determine whether m is incremented as expected and/or to determine whether an ending value of m (e.g., a value of m for the final value of the test sequence) differs from a requested ending index.

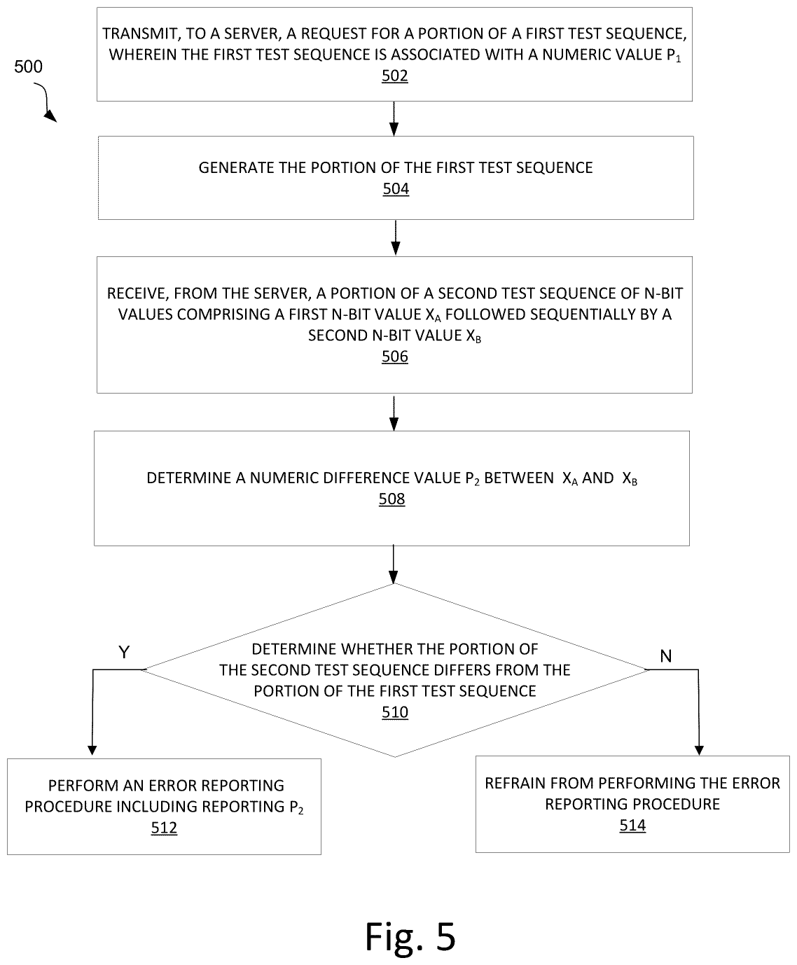

FIG. 4 depicts an illustrative example of using method 300 to generate a test sequence 400 using the sequence generation formula Xₘ=m P mod 2^{N} for the case when N=6 and P=17 and m ranges from 0 to 2^{N}−1 (e.g., mᵢₙᵢₜ=0). In this case, test sequence 400 is a sequence of 6-bit binary numbers (because N=6) where the first value in the test sequence is X₀=000000, the next sequential value is X₁=010001 (e.g., X₀+17 because P=17), and so on. Each sequential value is incremented by P (17) relative to the previous value, with the modulo function of the sequence generation equation (mod 2^{N}) eliminating the higher-order bits.

Test sequence 400 is also illustrated as a decimal sequence 402 and a 64×64 grid of non-repeating values 404 for illustrative purposes.

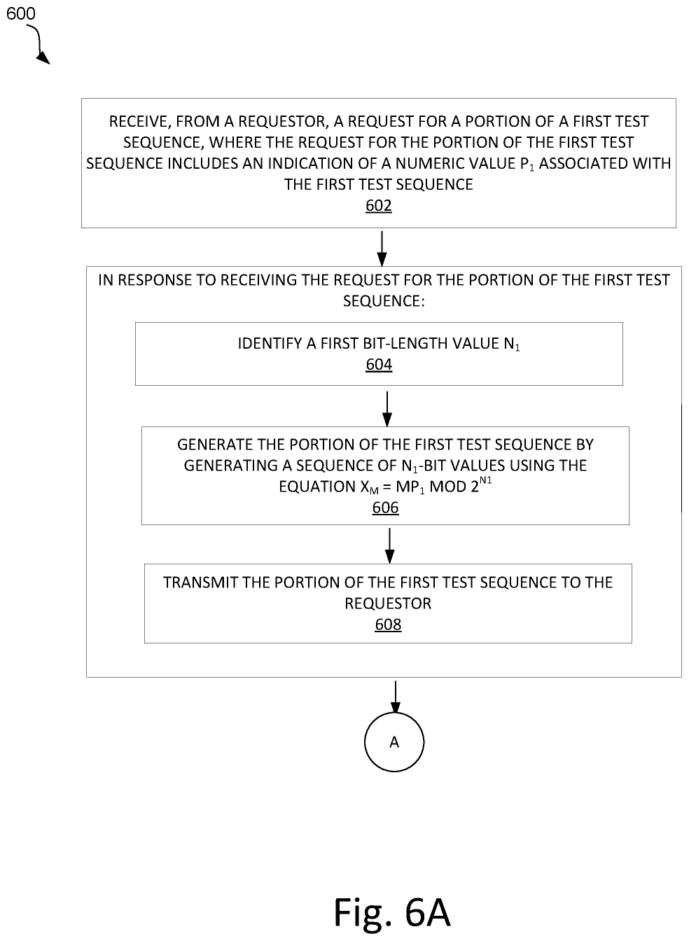

FIG. 5 depicts an example method 500 for verifying content delivery in a CDN. Method 500 may be performed by a client device (e.g., client device 106).

At operation 500, a client device transmits, to a server (e.g., edge server 104 or origin server 102), a request for a portion of a first test sequence, where the first test sequence is associated with a numeric value P₁ of parameter P. For example, the first test sequence is a test sequence that is generated using parameter P=P₁. In some examples, the request for the portion of the first test sequence includes an indication of P₁. The indication of P₁ may be an explicit indication (e.g., the request includes a parameter that specifies P₁) or an implicit indication (e.g., the request made to a URL that is associated with P₁, such that the request will be interpreted by the server as a request for the first test sequence using P₁). In some examples, the request includes an indication of an offset (e.g., mᵢₙᵢₜ) at which the portion of the first test sequence should begin (e.g., the client device requests a subset of the generated test sequence starting from the offset) and/or an indication of the number of bits N₁ of each value of the first test sequence (e.g., parameter N=N₁). In some examples, the request includes an indication of a length of the portion of the test sequence, such as an ending index m_{final} or a number of bytes.

In some examples, the client device identifies (e.g., selects) the value of P=P₁ based on information stored on the client device or based on the output of a random number generator. In some examples, the client device identifies (e.g., selects) mᵢₙᵢₜ and/or N₁ based on information stored at the client device, such as a default setting or configuration setting. In some examples, the portion of the first test sequence includes the entire first test sequence (e.g., starting from X₀). In some examples, the portion of the first test sequence includes a subset of the first test sequence (e.g., a subset of the test sequence starting from Xₘᵢₙᵢₜ, where mᵢₙᵢₜ≠0 and/or ending at a final index value m_{final}<2^{N}−1).

At operation 504, the client device obtains the portion of the first test sequence. In some examples, the client device obtains the portion of the first test sequence by generating the portion of the first test sequence using the sequence generation formula Xₘ=mP mod 2^{N} for m=mᵢₙᵢₜ to 2^{N}−1 (or m=mᵢₙᵢₜ to m_{final}), using the parameter values of P=P₁, mᵢₙᵢₜ, (the offset value), N=N₁ (the number of bits per value), and m_{final}. In some examples, the client device obtains the portion of the first test sequence by retrieving the portion of the first test sequence from memory based on one or more of the parameter values.

At operation 506, the client device receives, from the server, a portion of a second test sequence of N-bit values including a first N-bit value X_{A} followed sequentially (e.g., without intervening values) by a second N-bit value X_{B}. For example, X_{A} may be the first value in the portion of the second test sequence and X_{B} may be the second value in the portion of the second test sequence, or X_{A} may be the second value in the portion of the second test sequence and X_{B} may be the third value, etc. In some examples, the portion of the second test sequence includes the entire second test sequence. In some examples, the portion of the second test sequence includes a subset of the second test sequence, such as a subset of the second test sequence that starts from an offset.

At operation 508, the client device determines a numeric difference P₂ between X_{A} and X_{B}. For example, the client device may subtract X_{A} from X_{B} to determine the numeric difference P₂. In some examples, the client device determines the numeric difference P₂ based on the first two values of the portion of the second test sequence or based on two other consecutive values of the portion of the second test sequence.

At operation 510, the client device determines whether the portion of the second test sequence differs from the portion of the first test sequence. In some examples, the client device determines whether the portion of the second test sequence differs from the portion of the first test sequence by comparing some or all of the values of the portion of the first test sequence with some or all of the corresponding values of the portion of the second test sequence to determine whether the portion of the second test sequence differs from the portion of the first test sequence. In some examples, the client device determines whether the portion of the second test sequence differs from the portion of the first test sequence by determining whether P₂ matches P₁. In some examples, the client device determines whether the portion of the second test sequence differs from the portion of the first test sequence by identifying an offset value of the portion of the second test sequence and comparing it to an offset value of the portion of the first test sequence, such as by determining mᵢₙᵢₜ for the portion of the second test sequence (e.g., the index of the first value in the portion of the second test sequence) and comparing it to mᵢₙᵢₜ for the portion of the first test sequence. In some examples, the client device determines whether the portion of the second test sequence differs from the portion of the first test sequence by determining whether a length of the portion of the second test sequence differs from a length of the portion of the first test sequence, such as by determining whether the final index value differs from a requested final index value.

In accordance with a determination that the portion of the second test sequence differs from the portion of the first test sequence, at operation 512, the client device performs an error reporting procedure that includes reporting (e.g., storing and/or transmitting) P₂. For example, the client device stores an entry in an error log and/or transmits a message that includes an indication of P₂, thereby indicating which (wrong) test sequence was actually received. In some examples, the error reporting procedure includes reporting N (the number of bits per value in the portion of the second test sequence), mᵢₙᵢₜ (the index of the first value of the portion of the second test sequence, the offset), and/or m_{final}. In some examples, the error reporting procedure includes reporting one or more of the parameters associated with the portion of the first test sequence, such as P₁, N₁, mᵢₙᵢₜ, and/or m_{final} for the portion of the first test sequence. In some examples, the error reporting procedure includes reporting additional information associated with the testing procedure, such as a date and/or time at which the request was transmitted, a date and/or time at which the portion of the second test sequence was received, an identifier of the client device, an identifier of the edge server, an identifier of the origin server, and/or other information.

In accordance with a determination that the portion of the second test sequence does not differ from the portion of the first test sequence (e.g., the portion of the second test sequence matches the portion of the first test sequence, or P₁ matches P₂, and/or the offset of the portion of the second sequence matches the offset of the portion of the first test sequence), at operation 514, the client device refrains from performing the error reporting procedure. In other examples, the client device may report a null set as an error report and/or report a “pass” or other indication of no error. For example, in accordance with a determination that the portion of the second test sequence does not differ from the portion of the first test sequence, the client device performs a different reporting procedure, such as by storing or transmitting information associated with the (successful) testing procedure.

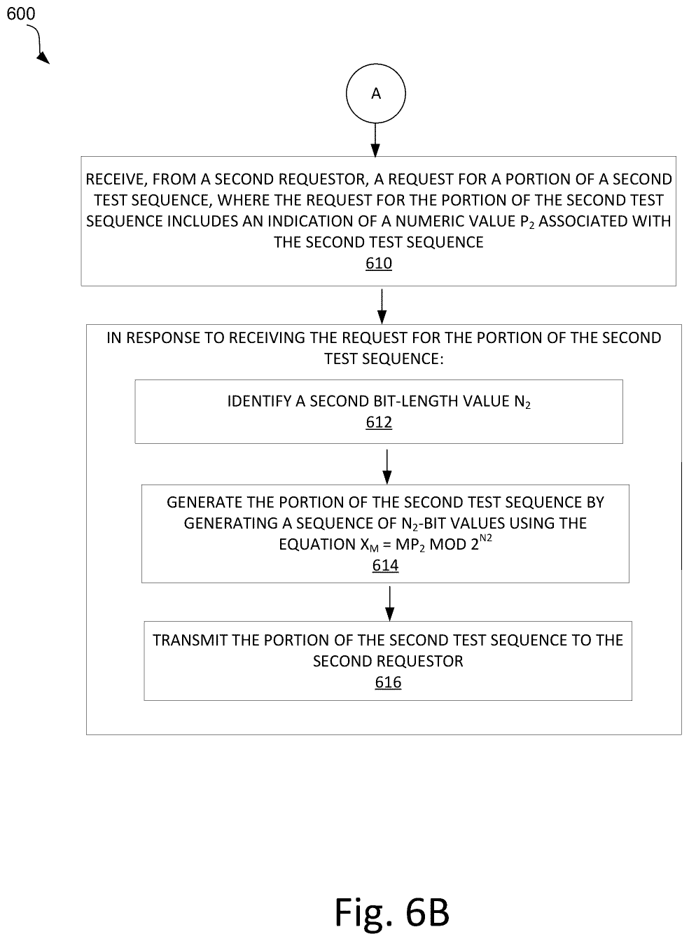

FIGS. 6A-6B depict an example method 600 for verifying content delivery in a CDN. Method 600 may be performed by an origin server (e.g., origin server 102) and/or an edge server (e.g., edge server 104). In this example, the operations are performed by an origin server.

At operation 602, the origin server receives, from a first requestor, a request for a portion of a first test sequence, where the request for the portion of the first test sequence includes an indication of a number value P₁ associated with the first test sequence. In some examples, the first requestor is a client device (e.g., client device 106) or a caching server (e.g., edge server 104 or an intermediate caching server).

In response to receiving the request for the portion of the first test sequence, the origin server performs operations 604-608.

At operation 604, the origin server identifies a first bit-length value N₁. For example, the origin server identifies the first bit-length value N₁ based on the request for the portion of the first test sequence (e.g., the request includes an explicit or implicit indication of N₁) or based on information stored on the origin server, such as configuration information.

At operation 606, the origin server generates the portion of the first test sequence by generating a sequence of N₁-bit values using the equation Xₘ=mP₁ mod 2^{N}₁, where m=mᵢₙᵢₜ₁ to 2^{N}₁−1 (or m=mᵢₙᵢₜ₁ to m_{final1}, if a final index value is specified). In some examples, the origin server identifies the range of values of m over which to generate the sequence of values based on the request (e.g., the request includes an explicit or implicit indication of a starting value mᵢₙᵢₜ₁ of m corresponding to an offset of the requested portion of the first test sequence and/or an explicit or implicit indication of m_{final1}) or based on information stored on the origin server, such as configuration information. In some examples, mᵢₙᵢₜ=0 (e.g., there is zero offset), which may be a default configuration setting (e.g., a value that may be used in the absence of an indication of mᵢₙᵢₜ₁ in the request). In some examples, the first test sequence may be stored as a file at the origin server (as opposed to being dynamically generated in response to the request for the portion of the first test sequence). The test file may be stored as associated with the value(s) of P and N so that it can be accessed when a request having those values is received. In such examples, the origin server generates the portion of the first test sequence by retrieving the requested portion from the stored test file.

At operation 608, the origin server transmits the portion of the first test sequence to the first requestor (e.g., to the requesting caching server or client device).

At operation 610, the origin server receives, from a second requestor, a request for a portion of a second test sequence, where the request for the portion of the second test sequence includes an indication of a number value P₂ associated with the second test sequence. In some examples, the second requestor is a client device (e.g., client device 106) or a caching server (e.g., edge server 104 or an intermediate caching server). In some examples, the second requestor is the same as the first requestor. In some examples, the second requestor is different from the first requestor.

In response to receiving the request for the portion of the second test sequence, the origin server performs operations 612-616.

At operation 612, the origin server identifies a second bit-length value N₂. For example, the origin server identifies the second bit-length value N₂ based on the request for the portion of the second test sequence (e.g., the request includes an explicit or implicit indication of N₂) or based on information stored on the origin server, such as configuration information. In some examples, N₂ is different from N₁. In some examples, N₂ is the same as N₁.

At operation 614, the origin server generates the portion of the second test sequence by generating a sequence of N₂-bit values using the equation Xₘ=mP₁ mod 2^{N}₂, where m=mᵢₙᵢₜ₂ to 2^{N}₂−1 (or m=mᵢₙᵢₜ₂ to m_{final2}, if a final index is specified) In some examples, the origin server identifies the range of values of m over which to generate the sequence of values based on the request for the portion of the second test sequence (e.g., the request includes an explicit or implicit indication of a starting value mᵢₙᵢₜ₂ of m corresponding to an offset of the requested portion of the second test sequence and/or an explicit or implicit indication of m_{final2}) or based on information stored on the origin server, such as configuration information. In some examples, mᵢₙᵢₜ₂=0 (e.g., there is zero offset), which may be a default configuration setting (e.g., a value that may be used in the absence of an indication of mᵢₙᵢₜ₂ in the request). In some examples, mᵢₙᵢₜ₂ is the same as mᵢₙᵢₜ₁. In some examples, mᵢₙᵢₜ₂ is different from mᵢₙᵢₜ₁. In some examples, the second test sequence may be stored as a file at the origin server (as opposed to being dynamically generated in response to the request for the portion of the second test sequence). In such examples, the origin server generates the portion of the second test sequence by retrieving the requested portion from the stored file.

At operation 616, the origin server transmits the portion of the second test sequence to the second requestor (e.g., to the requesting caching server or client device).

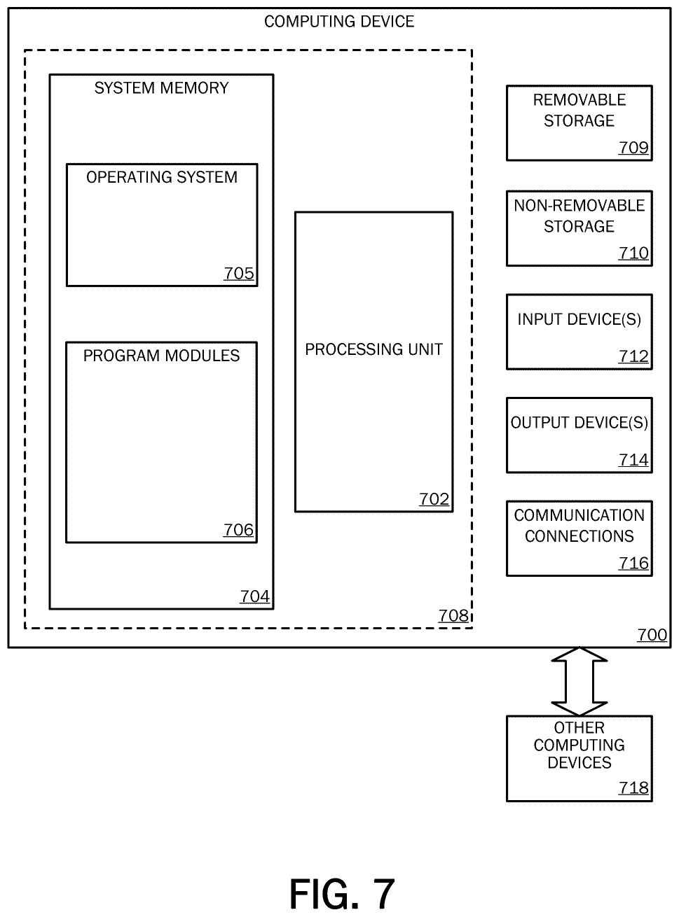

FIG. 7 is a block diagram illustrating physical components (i.e., hardware) of a computing device 700 with which examples of the present disclosure may be practiced. The computing device components described below may be suitable for a computing device(s) implementing (or included in) a client device 102, an edge server 104 (or other caching server), and/or an origin server 102. In a basic configuration, the computing device 700 may include at least one processing unit 702 and a system memory 704. The processing unit(s) (e.g., processors) may be referred to as a processing system. Depending on the configuration and type of computing device, the system memory 704 may comprise, but is not limited to, volatile storage (e.g., random access memory), non-volatile storage (e.g., read-only memory), flash memory, or any combination of such memories. The system memory 704 may include an operating system 705 and one or more program modules 706 suitable for running software applications 770 to implement one or more of the components or systems described above with respect to FIGS. 1-3.

The operating system 705, for example, may be suitable for controlling the operation of the computing device 700. Furthermore, aspects of the invention may be practiced in conjunction with a graphics library, other operating systems, or any other application program and is not limited to any particular application or system. This basic configuration is illustrated in FIG. 7 by those components within a dashed line 708. The computing device 700 may have additional features or functionality. For example, the computing device 700 may also include additional data storage devices (removable and/or non-removable) such as, for example, magnetic disks, optical disks, or tape. Such additional storage is illustrated in FIG. 7 by a removable storage device 709 and a non-removable storage device 710.

As stated above, a number of program modules and data files may be stored in the system memory 704. While executing on the processing unit 702, the program modules 706 may perform processes including, but not limited to, one or more of the operations of the methods illustrated in FIGS. 3A, 3B, 5, 6A, and 6B.

For example, if computing device 700 is included in a client device, program modules 706 may include one or more modules for identifying parameter values, transmitting requests for test sequences (e.g., to a caching server or origin server), generating test sequences, receiving test sequences (e.g., from a caching server or origin server), determining whether received test sequences match requested test sequences, extracting values of parameters from received test sequences, and performing error reporting procedures.

For example, if computing device 700 is included in an origin server, program modules 706 may include one or more modules for receiving requests for test sequences (e.g., from caching servers and/or client devices), identifying parameters for test sequence generation, generating test sequences based on received requests, and transmitting test sequences.

For example, if computing device 700 is included in a caching server, program modules 706 may include one or more modules for receiving requests for test sequences (e.g., from client devices or lower-level caching servers), obtaining test sequences (e.g., from a cache of the caching server, from higher-level caching servers, and/or from an origin server), and transmitting test sequences (e.g., to the requesting client device or lower-level caching server).

Other program modules that may be used in accordance with examples of the present invention and may include applications such as electronic mail and contacts applications, word processing applications, spreadsheet applications, database applications, slide presentation applications, drawing or computer-aided application programs, etc.

Furthermore, examples of the invention may be practiced in an electrical circuit comprising discrete electronic elements, packaged or integrated electronic chips containing logic gates, a circuit utilizing a microprocessor, or on a single chip containing electronic elements or microprocessors. For example, examples of the invention may be practiced via a system-on-a-chip (SOC) where each or many of the components illustrated in FIG. 7 may be integrated onto a single integrated circuit. Such an SOC device may include one or more processing units, graphics units, communications units, system virtualization units and various application functionality all of which are integrated (or “burned”) onto the chip substrate as a single integrated circuit. When operating via an SOC, the functionality, described herein, with respect to generating suggested queries, may be operated via application-specific logic integrated with other components of the computing device 700 on the single integrated circuit (chip). Examples of the present disclosure may also be practiced using other technologies capable of performing logical operations such as, for example, AND, OR, and NOT, including but not limited to mechanical, optical, fluidic, and quantum technologies.

The computing device 700 may also have one or more input device(s) 712 such as a keyboard, a mouse, a pen, a sound input device, a touch input device, etc. The output device(s) 714 such as a display, speakers, a printer, etc. may also be included. The aforementioned devices are examples and others may be used. The computing device 700 may include one or more communication connections 716 allowing communications with other computing devices 718 and/or systems (such as devices and/or systems depicted in FIG. 3). Examples of suitable communication connections 716 include, but are not limited to, RF transmitter, receiver, and/or transceiver circuitry; universal serial bus (USB), parallel, and/or serial ports.

The term computer readable media as used herein may include computer storage media. Computer storage media may include volatile and nonvolatile, removable and non-removable media implemented in any method or technology for storage of information, such as computer readable instructions, data structures, or program modules. The system memory 704, the removable storage device 709, and the non-removable storage device 710 are all computer storage media examples (i.e., memory storage.) Computer storage media may include RAM, ROM, electrically erasable programmable read-only memory (EEPROM), flash memory or other memory technology, CD-ROM, digital versatile disks (DVD) or other optical storage, magnetic cassettes, magnetic tape, magnetic disk storage or other magnetic storage devices, or any other article of manufacture which can be used to store information and which can be accessed by the computing device 700. Any such computer storage media may be part of the computing device 700 and/or coupled with computing device 700. Computer storage media may be non-transitory and tangible and does not include a carrier wave or other propagated data signal.

Communication media may be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media.

Aspects of the present invention, for example, are described above with reference to block diagrams and/or operational illustrations of methods, systems, and computer program products according to aspects of the invention. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved. Further, as used herein and in the claims, the phrase “at least one of element A, element B, or element C” is intended to convey any of: element A, element B, element C, elements A and B, elements A and C, elements B and C, and elements A, B, and C.

The description and illustration of one or more aspects provided in this application are not intended to limit or restrict the scope of the disclosure as claimed in any way. The aspects, examples, and details provided in this application are considered sufficient to convey possession and enable others to make and use the best mode of claimed disclosure. The claimed disclosure should not be construed as being limited to any aspect, example, or detail provided in this application. Regardless of whether shown and described in combination or separately, the various features (both structural and methodological) are intended to be selectively rearranged, included or omitted to produce an embodiment with a particular set of features. Having been provided with the description and illustration of the present application, one skilled in the art may envision variations, modifications, and alternate aspects falling within the spirit of the broader aspects of the general inventive concept embodied in this application that do not depart from the broader scope of the claimed disclosure.

What is claimed:

1. A method, comprising:
transmitting, to a server, a request for a portion of a first test sequence, wherein the first test sequence is associated with a numeric value P₁;
generating the portion of the first test sequence;
receiving, from the server, a portion of a second test sequence of N-bit values comprising a first N-bit value X_{A} followed sequentially by a second N-bit value X_{B};
determining a numeric difference value P₂ between X_{A} and X_{B};
determining that the portion of the second test sequence differs from the portion of the first test sequence; and
in accordance with the determination that the portion of the second test sequence differs from the portion of the first test sequence, performing an error reporting procedure including reporting P₂.

2. The method of claim 1, wherein determining that the portion of the second test sequence differs from the portion of the first test sequence comprises determining that P₁ differs from P₂.

3. The method of claim 1, wherein the numeric difference value P₂ is determined during the error reporting procedure.

4. The method of claim 1, wherein the request for the portion of the first test sequence includes an indication of P₁.

5. The method of claim 4, wherein the indication of P₁ is implicit in a uniform resource locator (URL) included in the request for the portion of the first test sequence.

6. The method of claim 1, further comprising:
determining a first offset mᵢₙᵢₜ associated with a value of an element Xᵢₙᵢₜ of the portion of the second test sequence based on the equation Xᵢₙᵢₜ=mᵢₙᵢₜP₂ mod 2^{N}, wherein determining that the portion of the second test sequence differs from the portion of the first test sequence comprises determining that mᵢₙᵢₜ differs from a second offset of the portion of the first test sequence.

7. The method of claim 6, wherein and the error reporting procedure includes reporting the first offset mᵢₙᵢₜ.

8. The method of claim 7, wherein the request includes an indication of the second offset of the portion of the first test sequence.

9. The method of claim 6, wherein the first offset mᵢₙᵢₜ is computed using an extended Euclidean algorithm to solve for mᵢₙᵢₜ in the equation Xᵢₙᵢₜ=mᵢₙᵢₜP₂ mod 2^{N}.

10. The method of claim 1, wherein the request includes an indication of N.

11. The method of claim 1, further comprising:
obtaining P₁ and N, wherein the portion of the first test sequence is generated using P₁ and N in the equation Xₘ=mP₁ mod 2^{N}.

12. The method of claim 1, wherein P₁ is an odd integer having a property that equation Xₘ=mP₁ mod 2^{N} produces unique values of Xₘ for 0≤m≤2^{N}−1.

13. The method of claim 1, wherein the second test sequence includes a third N-bit value X_{D} sequentially following the second N-bit value X_{B}, where a numeric difference between X_{B} and X_{D} is P₂.

14. A method, comprising:
receiving, from a requestor, a request for a portion of a first test sequence, wherein the request for the portion of the first test sequence comprises an indication of a numeric value P₁ associated with the first test sequence; and
in response to receiving the request for the portion of the first test sequence:
identifying a first bit-length value N₁,
generating the portion of the first test sequence by generating a sequence of N₁-bit values using the equation Xₘ=mP₁ mod 2^{N}₁, and
transmitting the portion of the first test sequence to the requestor.

15. The method of claim 14, wherein the requestor is a first caching server or a first client device.

16. The method of claim 14, further comprising:
receiving, from a second requestor, a request for a portion of a second test sequence, wherein the request for the second test sequence comprises an indication of a numeric value P₂ associated with the second test sequence; and
in response to receiving the request for the portion of the second test sequence:
identifying a second bit-length value N₂,
generating the portion of the second test sequence by generating a sequence of N₂-bit values using the equation Yₘ=mP₂ mod 2^{N}₂, and
transmitting the portion of the second test sequence to the second requestor.

17. A content delivery network (CDN), comprising:
An origin server comprising at least a first processor and first memory operatively connected to the at least the first processor and storing first instructions;
a caching server comprising at least a second processor and second memory operatively connected to the at least the second processor and storing second instructions; and
a client device comprising at least a third processor and third memory operatively connected to the at least the third processor and storing third instructions;
wherein:
the origin server is operatively connected to the caching server, and the first instructions, when executed by the at least the first processor, cause the origin server to perform a first method, the first method comprising:
receiving, from the caching server, a first request for a first data stream, and in response to the first request: identifying a first value P₁ of a parameter P based on the first request, generating the first data stream based on P₁, and transmitting the first data stream to the caching server;
the caching server is operatively connected to the client device, and the second instructions, when executed by the at least the second processor, cause the caching server to perform a second method, the second method comprising:
receiving a second request for a second data stream from the client device comprising an indication of a second value P₂ of a parameter P, and in response to receiving the second request: obtaining, from a cache of the caching server or from the origin server, a third data stream based on P₂, and transmitting the third data stream to the client device; and
the third instructions, when executed by the at least the third processor, cause the client device to perform a third method, the third method comprising:
transmitting a third request for a fourth data stream to the caching server wherein the third request comprises an indication of a third value P₃ of parameter P, generating the fourth data stream based on P₃, receiving a fifth data stream from the caching server, the fifth data stream comprising a sequence of N-bit values comprising a first N-bit value X_{A} followed sequentially by a second N-bit value X_{B}, determining, by the client device, a fourth value P₄ of parameter P based on a difference between X_{A} and X_{B}, determining whether the third data stream differs from the fourth data stream, and in accordance with a determination that the third data stream differs from the fourth data stream, performing an error reporting procedure including reporting P₄.

18. The CDN of claim 17, wherein generating the first data stream based on P₁ comprises generating a sequence of N₁-bit values using the equation Xₘ=mP₁ mod 2^{N}₁.

19. The CDN of claim 17, wherein generating the fourth data stream based on P₃ comprises generating a sequence of N₂-bit values using the equation Xₘ=mP₃ mod 2^{N}₂.

20. The CDN of claim 17, wherein obtaining the third data stream based on P₂ comprises sending, to the origin server, a request for the third data stream comprising an indication of P₂ and receiving the third data stream from the origin server.
